(19) United States
(12) Patent Application Publication
(10) Pub. No.: US 2015/0324782 A1
(43) Pub. Date: Nov. 12, 2015

(54) Automated Purchasing and Dispensing System for Livestock Feed

(71) Applicant: Tucker Milling, LLC, Guntersville, AL (US)

(72) Inventor: Brian D. Tucker, Guntersville, AL (US)

(21) Appl. No.: 14/706,442

(22) Filed: May 7, 2015

Related U.S. Application Data
(60) Provisional application No. 61/989,948, filed on May 7, 2014.

(51) Int. Cl. G06Q 20/20

(52) U.S. Cl. CPC G06Q 20/208

(57) ABSTRACT

An automated purchasing and dispensing system for livestock feed comprises a plurality of bulk storage containers for storing and dispensing bulk product such as animal feed. The bulk storage containers are enclosed within an enclosure, the enclosure comprising a consumer-accessible point of sale terminal for initiating a purchase. After a consumer initiates a purchase at the point of sale terminal, a system controller actuates a conveyor, causing the product to dispense from the bulk storage container onto a conveyor that moves the product to a dispensing station for access by the consumer.

### CROSS REFERENCE TO RELATED APPLICATIONS

This application claims the benefit of, and priority to, pending U.S. Provisional Application No. 61/989,948 filed May 7, 2014 titled “Automated Purchasing and Dispensing System for Livestock Feed,” incorporated herein by reference.

### BACKGROUND AND SUMMARY

Many companies in various agricultural industries are involved in the buying and selling of feed for livestock. Typically, feed is pre-packaged in set amounts and purchased in bulk quantities. This pre-packaging increases prices for both the dealer and consumer, due to labor and materials costs associated with packaging the feed.

Certain capabilities for feed distribution currently exist, but normally involve either the packaging of bulk quantities listed above or a labor-intensive process of dividing the pre-packaged feed into smaller quantities for individual purchase. Due to these issues, a need exists for an automated system for providing multiple types of livestock feed in various quantities chosen by the consumer, without the need to package the feed beforehand.

In view of the foregoing shortcomings inherent in the conventional type of methods and systems now present in the prior art, the present disclosure describes a system for automating both the purchase and dispense of multiple varieties of stored livestock feed.

In one embodiment, the automated purchasing and dispensing system for livestock feed comprises at least one bulk storage container, a conveyor, a dispensing station, and a consumer-accessible point of sale terminal.

In another embodiment, the automated purchasing and dispensing system for livestock feed comprises at least one bulk storage container, a slide gate at the base of the bulk storage container, a conveyor, a dispensing station, a visual display for the selection of products, and a consumer-accessible point of sale terminal.

Other objects and advantages of the system will become obvious to the reader and it is intended that these objects and advantages are within the scope of the present disclosure.

To the accomplishment of the above and related objects, the system according to the present disclosure may be embodied in the form illustrated in the accompanying drawings and figures, recognizing however, that the drawings are illustrative only, and that changes may be made in the specific construction illustrated and described within the scope of the appended claims.

### BRIEF DESCRIPTION OF DRAWINGS

It should be noted that identical features in different drawings are shown with the same reference numeral.

FIG. 1 is a front perspective view of an automated purchasing and dispensing system for livestock feed in accordance with one embodiment of the present disclosure.

FIG. 2 is a functional diagram of the inside of an automated purchasing and dispensing system for livestock feed in accordance with one embodiment of the present disclosure.

FIG. 3 is a side-view diagram of an automated purchasing and dispensing system for livestock feed in accordance with one embodiment of the present disclosure.

FIG. 4 is a partial rear perspective view of the inside of an automated purchasing and dispensing system for livestock feed, as shown from the rear of the system, in accordance with one embodiment of the present disclosure.

FIG. 5 is a block diagram illustrating a system in accordance with an exemplary embodiment of the present disclosure.

FIG. 6 depicts an exemplary system controller as depicted in FIG. 5.

### DETAILED DESCRIPTION

A system for automated purchasing and dispensing related to livestock feed has been developed. It should be understood that the automated purchasing and dispensing performed by the system may be applied to a broad range of materials, including but not limited to livestock feed, pet food, grain, seed, and other dry agricultural products, all of which are referred to generally as “product” or “products” herein.

A system according to the present disclosure allows a user to obtain different products in varying amounts, while allowing the user to purchase these materials at all times of the day. In one embodiment, the system involves a one-time purchase by the consumer of a specific container, which may be any one of a variety of items, such as a bucket, box, bag, pail, carrier, or other type of container that can hold the product. The containers can be purchased in varying sizes, such as 3.5, 5, or 6.5 gallons. Each of these containers will have a built-in identification sensor, such as a radio-frequency identification (“RFID”) tag or barcode reader, enabling the system to recognize the container's size and corresponding weight limit. Thereafter, the consumer can approach the system at any time of day, using a point of sale terminal, and obtain the desired amount of feed.

Due to its automated nature, the system according to the present disclosure provides the capability for products to be purchased without regard to normal operating hours, allowing more flexibility for consumers and eliminating the need for an attendant.

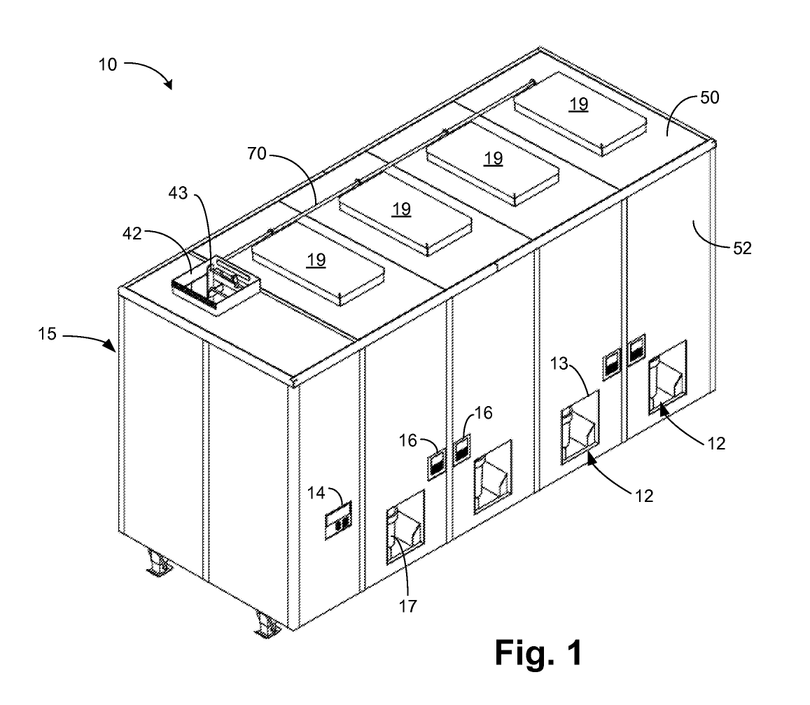

FIG. 1 is a front perspective view of an automated purchasing and dispensing system 10 for livestock feed in accordance with one embodiment of the present disclosure. In this embodiment, the system 10 includes an enclosure 15 that contains the system 10. The enclosure 15 comprises ports 19 for loading product (not shown) into bulk storage containers (not shown) that are within the enclosure 15. The enclosure 15 also includes a port connector 70 on the top side 50, which is coupled to each of the lids (not shown) of the ports 19 and allows the ports 19 to be opened simultaneously.

The enclosure 15 may be stationary or mobile in nature. For example, the enclosure 15 may sit on any number of permanently attached axles and be movable. Similarly, the enclosure 15 may include a detachable hitch and axle so that it is mobile, where the hitch and axle may be removed after the enclosure 15 has been parked in the desired location. The enclosure 15 may also sit permanently on non-movable objects, such as blocks, frames, foundations, or other types of support.

The enclosure 15 may include an access opening 42 on the top side 50, and a ladder 43 extending from the top side 50 downwardly to allow access to the interior components of the system 10 for maintenance. Other embodiments may include a side opening (not shown) on one side of the enclosure 15, which may be in addition to or in place of the access opening 42 on the top side 50 of the enclosure 15. Similar to the access opening 42, a side opening (not shown) allows access to the interior components of the system 10.

The system 10 also includes a plurality of dispensing stations 12, which in the illustrated embodiment are recessed into a front side 52 of the enclosure 15. In other embodiments, the dispensing stations 12 may extend outwardly from the enclosure 15, or the dispensing stations 12 may be a separate structure fixed to the front side 52 of the enclosure 15. The dispensing stations 12 comprise openings 13 that are generally rectangular in shape, and a scale (not shown) that supports a container 17 into which products are dispensed. The scale (not shown) further weighs the container 17, as further discussed herein.

Each opening 13 is sized large enough to receive a container 17 during the dispensing process. In some embodiments, a door (not shown) covers the opening 13 when the dispensing station 12 is not in use. The illustrated system 10 comprises four (4) dispensing stations 12, which correspond to four (4) bulk storage containers (not shown).

Other embodiments may comprise more or fewer dispensing stations 12, depending on the number of bulk storage containers (not shown) desired.

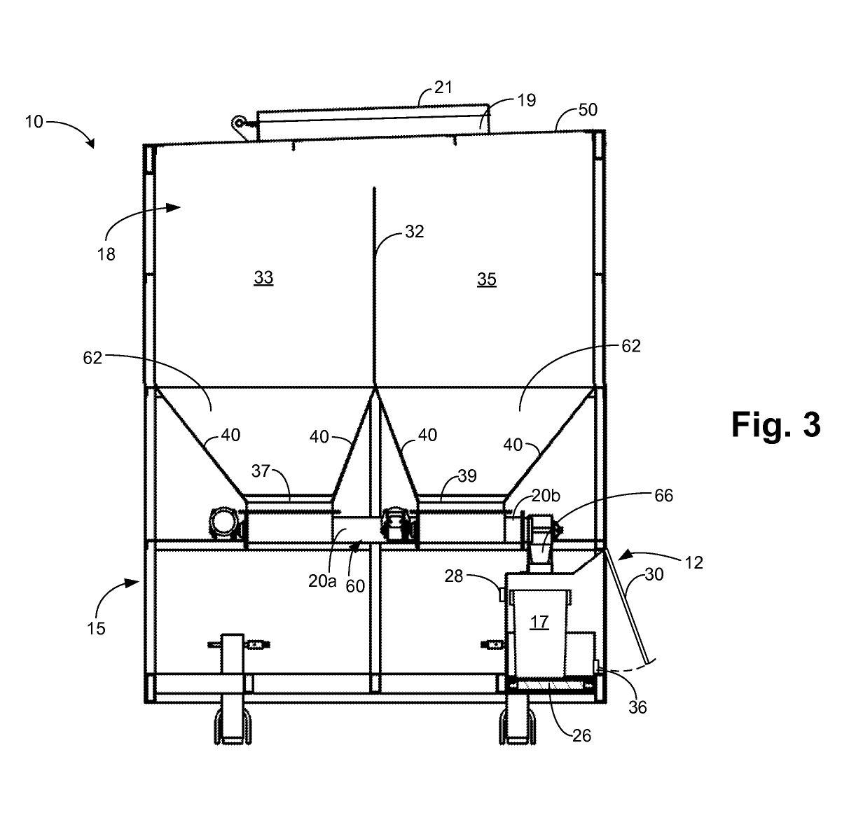

Each of the dispensing stations 12 may dispense different types of products as determined by the seller, and the functionality of the individual dispensing stations 12 is more fully described below and shown in FIG. 3.

A consumer-accessible point of sale terminal 14 is disposed on the front side 52 of the enclosure 15 in the illustrated embodiment. The point of sale terminal 14 includes an electronic payment processor (not shown), which may be a commonly-used magnetic strip reader for credit and debit cards. The point of sale terminal 14 also includes a consumer interface (not shown), such as a touch-screen display, or a visual display with corresponding manual buttons.

Each of the dispensing stations 12 is associated with a digital display 16. The digital displays 16 are disposed on the front side 52 of the enclosure 15 near their associated dispensing stations 12 in the illustrated embodiment. The individual digital displays 16 each include a visual display (not shown) that displays the product output or other product-related information, such as the quantity purchased or purchase price, for example. A fill button (not shown) may also be located at each of the dispensing stations 12. If the individual digital display 16 is a type of touch-screen display, the fill button (not shown) may be located within the digital display 16. Alternatively, the fill button (not shown) may be located adjacent to each of the digital displays 16, allowing for a mechanical fill button.

In operation of the system 10, a consumer initiates a transaction by using an electronic form of payment, such as a credit or debit card, in the point of sale terminal 14 and subsequently choosing an amount and type of product. The point of sale terminal 14 may include a user-input interface which allows the consumer to choose a specific type of feed or other product. For example, the consumer may utilize a touch-screen system in order to conduct the purchase with his credit card, as well as indicate the type and amount of product desired. As another example, the point of sale terminal 14 may include a plurality of buttons for the consumer to indicate which product is chosen, and pursuant to a pre-programmed price, thereafter make his corresponding purchase with the credit card reader.

After making electronic payment and choosing the desired product, the consumer proceeds to the appropriate dispensing station 12 according to the type of feed chosen. Based on the product chosen, the system 10 will notify the consumer of which dispensing station 12 to use. The system 10 may notify the consumer which dispensing station 12 is correct by activating an indicator light (not shown) at the appropriate dispensing station 12. In addition, the system 10 may only unlock the dispensing station 12 door (not shown), as more fully described below, at the correct dispensing station 12.

After the door is unlocked, the consumer can insert the container 17 through the opening 13 and into the enclosure 15, setting the container 17 on the floor of the dispensing station 12. The consumer then actuates the fill button (not shown), and the system 10 causes the product (not shown) to dispense into the container 17.

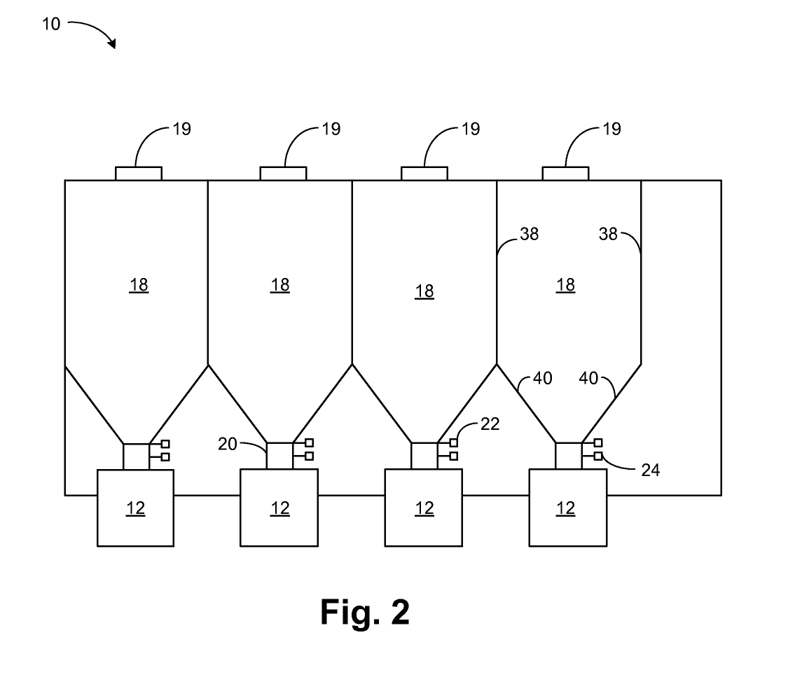

FIG. 2 is a functional front view diagram of the inside of an exemplary system 10, as shown in FIG. 1, in accordance with one embodiment of the present disclosure. In this example, each dispensing station 12 is supplied by an individual bulk storage container 18, which can be loaded with contents from the top, through individual ports 19. Because the bulk storage containers 18 may hold varying materials, allowing the seller to offer consumers an assortment of products, each bulk storage container 18 is separated from other bulk storage containers 18 by vertical walls 38.

Each bulk storage container 18 also includes angled walls 40, located in the lower portion of the bulk storage container 18. The angled walls 40 funnel the contents of the bulk storage container 18 into a conveyor system located at the bottom of the bulk storage container 18; the conveyor system in turn moves the product to the dispensing station 12.

In this regard, each bulk storage container 18 funnels its contents into a conveyor 20, which is operated by a conveyor motor 22 and conveyor gearbox 24. A conveyor controller (not shown) may be linked to each of the conveyor motors 22 to direct the operation of specific dispensing stations 12, based on the consumer's purchasing choice. The conveyor motor 22 may be run by different types of power systems, such as electric, hydraulic, or pneumatic power.

FIG. 3 shows a side-view diagram of the system 10 in accordance with an exemplary embodiment of the present disclosure. In this example, a vertical divider 32 in the center of the bulk storage container 18 allows the product to be dispensed from one side at a time. The use of a divider 32 provides the system 10 with the ability to dispense the freshest product available in the bulk storage container 18.

In this regard, the product (not shown) is loaded through top ports 19 of the system 10, located on the top side 50 of the enclosure 15. The top ports 19 may comprise an opening (not shown) that is covered by a lid 21. The lid 21 may be hinged to allow easy movement, or the lid 21 may be removable. The lid 21 may also be connected to a port connector (not shown), which couples each of the port lids 21 to one another. The port connector (not shown) may be attached to one lever (not shown) that when activated, opens all of the port lids 21 simultaneously. The lid 21 protects the product (not shown) from animals, weather, and theft. As a result, the lid 21 may contain a lock (not shown) to prevent unauthorized removal. In addition, the lid 21 may include a weather-proof seal to keep water out of the bulk storage containers 18. To aid with the prevention of water damage, the top side 50 of the enclosure 15 may be slanted at an angle to allow for water drainage, as shown in the illustrated embodiment.

Once loaded through the top ports 19, the product fills both a first side 33 and a second side 35 of the bulk storage container 18. A gate 37 on the bottom of the first side 33 will be open to allow dispensing from the first side 33 until all of the product has been dispensed from the first side 33. Thereafter, the gate 37 will be closed, and a gate 39 on the bottom of the second side 35 will open to allow dispensing from the second side 35. At some point before the product is completely emptied from the second side 35, new product will be loaded, the first gate 37 will be opened, and product will be dispensed from the first side 33 again. In this manner, the product will be effectively “rotated” such that old product does not linger in the bulk storage container 18 undistributed.

In the illustrated embodiment, each of the gates 37 and 39 at the bottom of the bulk storage container 18 are slide gates known in the industry, however other types of movable gates are contemplated by the present disclosure, such as valves or flaps. These slide gates 37 and 39 are disposed horizontally and slide to uncover openings (not shown) that allow the product to move (aided by gravity) from the bottom of the bulk storage container 18 to the conveyor 20 located underneath the bulk storage container 18. The slide gates 37 and 39 are electronically actuated, as further discussed herein. Other embodiments of the present disclosure do not include slide gates 37 or 39, but instead move product directly through the first side 33 and second side 35 to the conveyors 20.

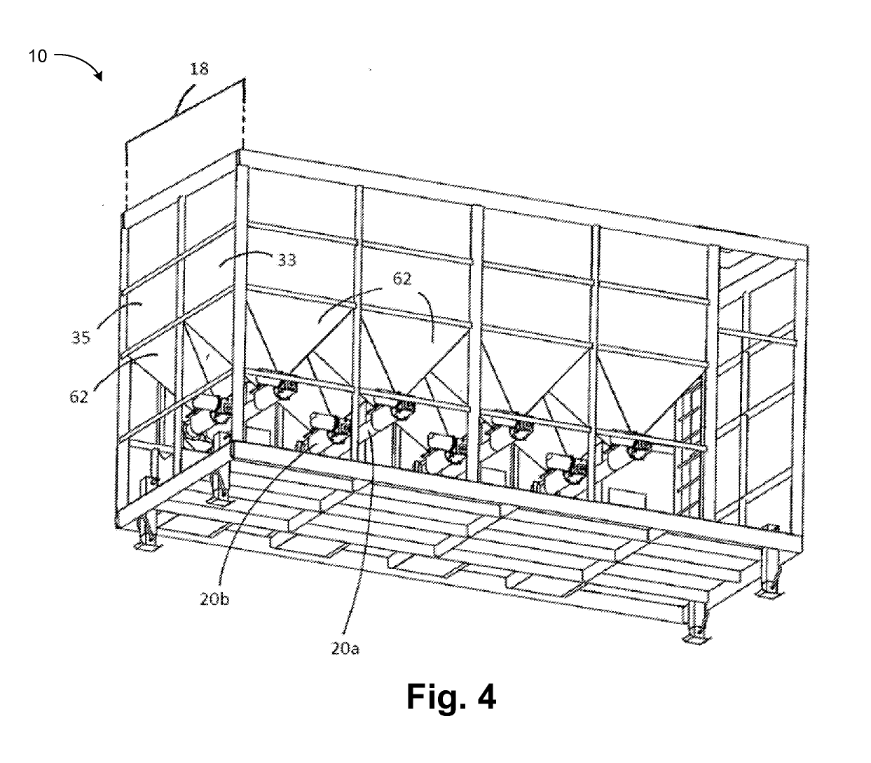

The conveyor 20 moves the product from the slide gates 37 and 39, where the product exits the bulk storage container 18, to the dispensing station 12. In embodiments that do not include slide gates 37 and 39, the conveyor 20 moves the product directly from the bulk storage container 18 to the dispensing station 12. Several different types of conveyor methods can be used, such as belts, augers, or drag conveyors. In the illustrated embodiment, auger (screw) conveyors are shown, and as a result these auger conveyors 20 are encapsulated in cylindrical housings 60. Each slide gate 37 and 39 may be coupled to its own conveyor 20, as shown in FIG. 4. Slide gate 37 couples to conveyor 20a, and slide gate 39 couples to conveyor 20b. Similarly, embodiments without slide gates may have the bottom of the first side 33 coupled to conveyor 20a, and the bottom of the second side 35 coupled to conveyor 20b. As shown in FIG. 2, each conveyor 20 is operated by a conveyor motor 22, which is directed by the consumer's initial purchase at the point of sale terminal 14, as well as the consumer's operation of the fill button (not shown). In this regard, the two tapered bases 62 of the first side 33 and the second side 35 may be offset horizontally from one another, allowing for two conveyors 20a and 20b side by side, as shown in FIG. 4 and further described below.

FIG. 3 also shows a side view of a dispensing station 12 in accordance with one embodiment of the present disclosure. Each dispensing station 12 is a hollow box-shaped structure, allowing a consumer to insert a container 17 for filling. The dispensing station 12 may be made of steel or other similar material, but if a door 30 is included in the dispensing station 12, the door 30 may be made of a transparent material, such as an acrylic or plastic substance. The conveyors 20a and 20b terminate above the dispensing station 12, and a channel 66 directs product (not shown) from the conveyors 20a and 20b into the container 17. In this example, a scale 26 is located at the base of the dispensing station 12, allowing the system 10 to measure, by weight, the amount of product dispensed.

Each door 30 to a dispensing station 12 contains a door lock 36 to prevent the door 30 from being opened during product dispensing. The door lock 36 may be a magnetically-actuated lock, for example, that is automatically controlled by the system 10 as further discussed herein. One advantage provided by the door lock 36 is the avoidance of tampering with the scale 26, since product purchasing and dispensing is dependent upon weight.

In addition to the door lock 36, each dispensing station 12 also contains a delivery sensor 28 to ensure appropriate dispensing. When a consumer places the container 17 into the dispensing station 12, the delivery sensor 28 ensures not only that a container compatible with the system 10 has been placed within the dispensing station 12, but also that the container's size corresponds with the amount of product purchased. If a compatible container 17 is used, the delivery sensor 28 may initiate an automatic cutoff when weight reaches a certain pre-set limit, ensuring that the consumer will not overfill the container 17.

Any of a number of sensors may be used for the delivery sensors 28 within the dispensing station 12 and containers 17. As examples, the containers 17 could include embedded RFID tags, or the containers 17 could include barcodes. An RFID tag reader or barcode reader would be utilized in each dispensing station 12 to ensure that the container 17 placed in it is compatible with the system 10.

If a consumer places a container 17 without an embedded identification tag within the dispensing station 12, that is, a container 17 that is not designed to work with the system 10, the system 10 will not operate. An error message may be displayed for the user on the digital display (not shown) or the point of sale terminal (not shown) display, and no action will occur if the consumer presses the fill button (not shown).

With regard to the general operation of the dispensing station 12, when making a purchase, the consumer places a container 17 inside the dispensing station 12 of choice and subsequently closes the door 30 to the dispensing station 12. A fill button located at or near the digital display (not shown) of each dispensing station 12 is pressed by the consumer to begin filling the container 17 with the chosen product. The digital display (shown in FIG. 1) provides information such as weight and purchase amount to the consumer. As noted above, there may be an automatic shut off when the purchased amount (weight) is reached, or if the system 10 indicates that the weight has reached the particular container's capacity. After the container 17 is filled, the door 30 is unlocked, allowing the consumer to remove the container 17 containing the purchased product.

FIG. 4 is a partial rear perspective view of the system 10 of FIG. 1, in accordance with an alternate embodiment of the present disclosure. In this example, each bulk storage container 18 is shown having a first side 33 and second side 35 with separate tapered bases 62, as more fully described with regard to FIG. 3 above. This example shows the two tapered bases 62 horizontally offset from one another, and the conveyors 20a and 20b side by side. As a result, each of the gates (not shown) move product into a separate auger conveyor: product from the first side 33 is moved to the dispensing outlet (not shown) through conveyor 20a, and product from the second side 35 is moved to the dispensing outlet (not shown) through conveyor 20b.

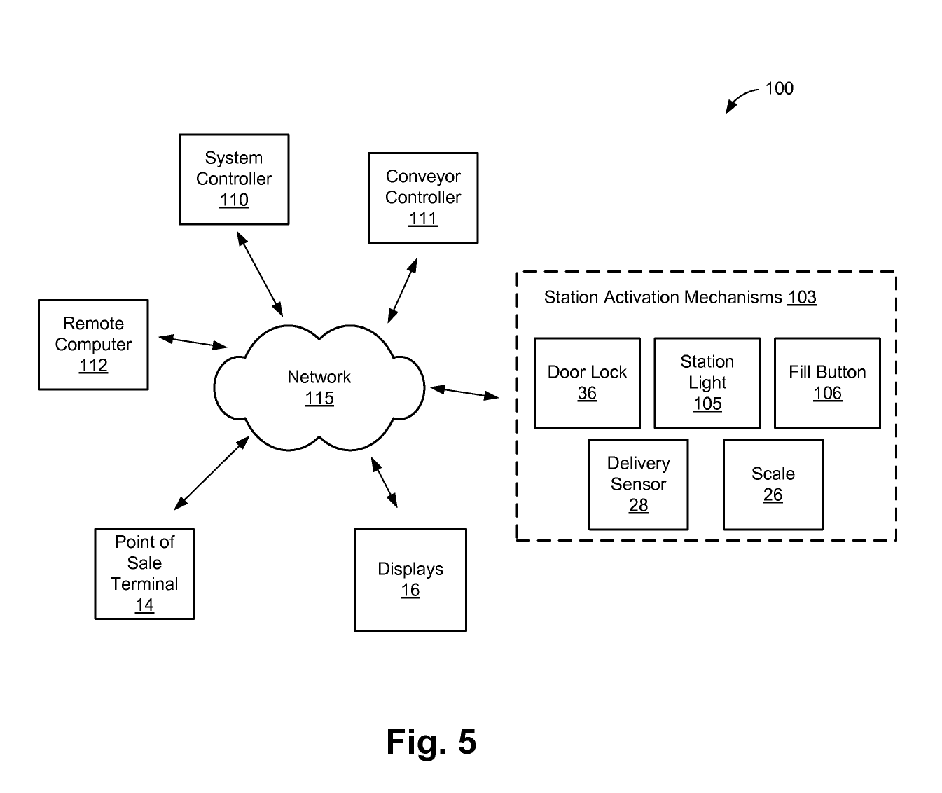

FIG. 5 illustrates a system 100 in accordance with an exemplary embodiment of the present disclosure. The system 100 comprises a system controller 110 that controls the performance of the system 100. The system controller 110 is generally located within the enclosure 15 (FIG. 1), though may be located remotely in other embodiments. A conveyor controller 111 controls the operation of the conveyors 20 (FIG. 3) and the gates 37 and 39 (FIG. 3). Although FIG. 5 shows the system controller 110 and the conveyor controller 111 as two separate items, the system controller 110 and the conveyor controller 111 may be packaged into one device in certain embodiments. The system controller 110 and the conveyor controller 111 may be any suitable computer known in the art or future-developed.

The system controller 110 and the conveyor controller 111 may communicate with each other and with other components in the system 100 over a network 115. The network 115 may be of any type network or networks known in the art or future-developed, such as the internet backbone, Ethernet, Wifi, WiMax, broadband over power line, coaxial cable, and the like. The network 115 may be any combination of hardware, software, or both.

A remote computer 112 may communicate with the system controller 110 over the network 115 as well. The remote computer 112 is generally located remotely from the enclosure 15 (FIG. 1). For example, if the enclosure 15 is located outside of a store (not shown), the remote computer 112 may be located within the store, such that employees in the store can remotely monitor and control the system 100. Alternatively, the remote computer 112 could be used by an attendant inside a store to accept cash for a purchase and then the remote computer 112 could communicate to the system controller 110 that payment has been made, such that the system controller 110 can initiate the dispensing process. The remote computer 112 may be any suitable computer known in the art or future-developed.

The system controller 110 also communicates with the point of sale terminal 14 over the network 115. Although FIG. 5 shows the system controller 110 and the point of sale terminal 14 as two separate items, the system controller 110 and the point of sale terminal 14 may be packaged into one device in certain embodiments.

The displays 16 communicate with the point of sale terminal 14 and/or the system controller 110 via the network 115. As discussed above, each dispensing station 12 (FIG. 1) has an associated display 16. Each dispensing station 12 further comprises a plurality of station activation mechanisms 103. The station activation mechanisms 103 comprise an automatic door lock 36, which locks and unlocks the door (not shown) of the dispensing station 12. The door lock 36 maintains the door (not shown) in a locked state until a user has purchased product via the point of sale terminal 14. At that point the system controller 110 prompts the door lock 36 to unlock to allow a user (not shown) to open the door (not shown) and insert a container 17 into the dispensing station 12. The system controller 110 locks the door (not shown) before the product is dispensed and unlocks it after the product dispensing is complete to allow the user to remove the container 17 from the dispensing station 12. After the container 17 has been removed from the dispensing station 12, the system controller 110 prompts the door lock 36 to re-lock the door.

In the illustrated embodiment, the station activation mechanisms 103 further comprise a dispensing station light 105 associated with each dispensing station 12. The dispensing station light 105 illuminates the dispensing station 12 when a user has purchased feed to be dispensed at that dispensing station 12. Further, the dispensing station light 105 may act as a signal to the user to indicate the dispensing station 12 where the purchased feed will be dispensed. The system controller 110 controls the operation of dispensing station lights 105. In this regard, after the user has purchased product at the point of sale terminal 14, the system controller 110 prompts the dispensing station light 105 to illuminate. After the product is dispensed and the container (not shown) has been removed from the dispensing station 12, the system controller 110 prompts the dispensing station light 105 to turn off.

The delivery sensor 28 senses when an authorized container 17 is in the dispensing station 12 and reports to the system controller 110 if the container 17 is compatible with the system 100. In this regard, the delivery sensor 28 may comprise an RFID tag reader and the container 17 may comprise an RFID tag, for example. The delivery sensor 28 senses the container 17 when the container 17 is within a predetermined proximity of the delivery sensor 28. If a user attempts to dispense product into an “unauthorized” container 17, e.g., a container that does not have an RFID tag, the delivery sensor 28 will not detect the container 17 and will thus not notify the system controller 110 to initiate dispensing of the product. In the illustrated embodiment, the system controller 110 will not initiate the product dispensing process until the propriety of the container 17 has been determined via the delivery sensor 28.

A scale 26 in the dispensing station 12 receives the container 17 and weighs the container 17 with the product as the product is being dispensed. The scale 26 reports the weight to the system controller 110, which stops the dispensing process when the scale 26 reports that the purchased weight of product has been received by the container 17.

The fill button 106 also communicates with the system controller 110 over the network 115. In this regard, after a user has placed an authorized container 17 into the dispensing station 12, the user may actuate the fill button 106 to initiate the dispensing process. The fill button 106 prompts the system controller 110 to command the conveyor controller 111 to actuate the gates 37 or 39 (FIG. 3), or to actuate the conveyors directly, and to cause the conveyor 20 (FIG. 3) to move product to the dispensing station 12 and dispense product into the container 17.

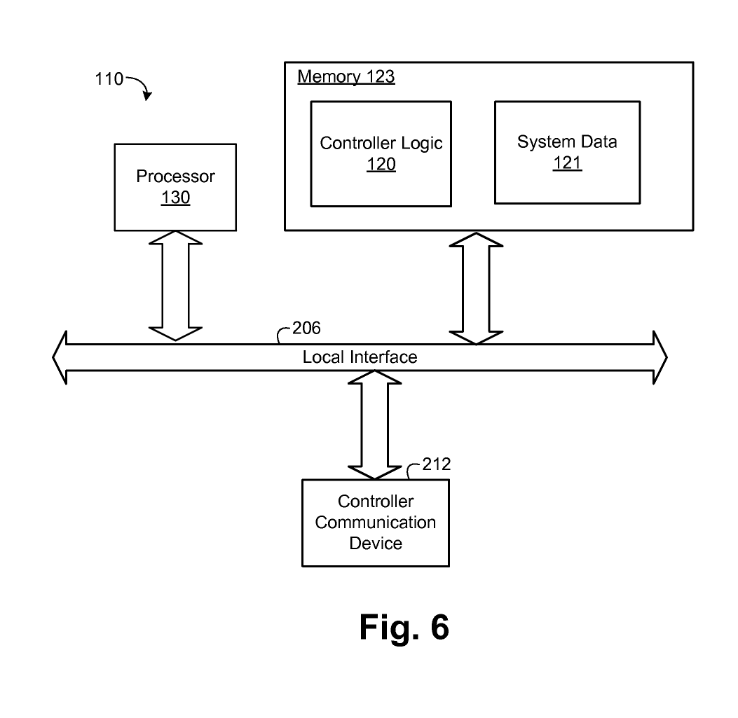

FIG. 6 depicts an exemplary system controller 110 as depicted in FIG. 5. The system controller 110 comprises controller logic 120 and system data 121. In the exemplary system controller 110, controller logic 120 and system data 121 are shown as stored in memory 123. The controller logic 120 and system data 121 may be implemented in hardware, software, or a combination of hardware and software.

The system controller 110 also comprises a processor 130, which comprises a digital processor or other type of circuitry configured to run the controller logic 120 by processing the controller logic 120, as applicable. The processor 130 communicates to and drives the other elements within the system controller 110 via a local interface 206, which can include one or more buses. When stored in memory 123, the controller logic 120 and the system data 121 can be stored and transported on any computer-readable medium for use by or in connection with logic circuitry, a processor, an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In one embodiment the controller communication device 212 connects to and communicates with the station activation mechanisms 103 (FIG. 5), the conveyor controller 111 (FIG. 5), the remote computer 112 (FIG. 5), the point of sale terminal 14, and the displays 16. The controller communication device 212 may also communicate with or comprise an input device, for example, a keyboard, a switch, a mouse, and/or other type of interface, which can be used to input data from a user of the system 100. The controller communication device 212 may also or alternatively communicate with or comprise a personal digital assistant (PDA), computer tablet device, laptop, portable or non-portable computer, cellular or mobile phone, or the like. The controller communication device 212 may also or alternatively communicate with or comprise a non-personal computer, e.g., a server, embedded computer, FPGA, microprocessor, or the like.

An additional system feature may include the capability to control the climate of the system interior. Although the present disclosure contemplates the distribution of dry products at ambient temperatures, the system may also be used to dispense materials needing a temperature-controlled storage environment. Similarly, the system may include a ventilation system in order to allow an attendant to maintain the controls of the system from within an enclosed room or compartment.

While the system according to the present disclosure has been described with respect to a limited number of embodiments, those skilled in the art, having benefit of this disclosure, will appreciate that other embodiments can be devised which do not depart from the scope of the system as disclosed here.

What is claimed is:

1. An automated purchasing and dispensing system comprising:
a plurality of bulk storage containers configured to dispense bulk products, the plurality of bulk storage containers disposed within an enclosure;
a conveyor for automatically moving bulk product from the bulk storage container to a dispensing station;
a system controller configured to control automatic dispensing of the bulk products;
a consumer-accessible point of sale terminal in communication with the system controller, wherein after a consumer purchases bulk product using the point of sale terminal, the system controller causes the conveyor to move the bulk product to the dispensing station for access by the consumer.

2. The system of claim 1, wherein the dispensing station is recessed into a front side of the enclosure.

3. The system of claim 1 further comprising a scale disposed at the dispensing station, the scale configured to weigh a container when the container is in the dispensing station, the scale further configured to report a container weight to the system controller during dispensing of the bulk product, the system controller configured to stop the dispensing of the bulk product when a purchased weight has been dispensed.

4. The system of claim 1, wherein the dispensing station comprises a delivery sensor configured to sense the presence of an authorized container at the dispensing station and report the presence of the authorized container to the system controller, the system controller further configured to initiate dispensing of bulk product only into authorized containers.

5. The system of claim 1 further comprising a dispensing station door and a door lock, the door lock automatically actuatable from a locked position to an unlocked position.

6. The system of claim 5, wherein the system controller is configured to unlock the door lock after a consumer purchases bulk product using the point of sale terminal, and to re-lock the door lock before initiating dispensing of bulk product.

7. The system of claim 1 further comprising a station light associated with each dispensing station.

8. The system of claim 7, wherein the system controller is configured to illuminate the station light after a consumer purchases bulk product to be dispensed at the dispensing station.

9. The system of claim 1, further comprising displays associated with each dispensing station, the displays configured to display product information to the consumer.

10. The system of claim 1, further comprising a remote computer, the remote computer located remotely from the enclosure, the remote computer in communication with the system controller over a network, the remote computer configured to monitor the system.

11. The system of claim 10, the remote computer further configured to initiate sales of bulk product remotely, the bulk product to be dispensed at the dispensing station.

12. An automated purchasing and dispensing system comprising:
at least one bulk storage container configured to dispense bulk animal feed;
a dispensing station accessible by a user, the dispensing station configured to dispense bulk animal feed into a removable container;
a system controller configured to control automatic dispensing of the bulk animal feed into the container;
a consumer-accessible point of sale terminal in communication with the system controller, wherein after a user purchases bulk animal feed using the point of sale terminal, the system controller causes the bulk storage container to dispense bulk animal feed into the container.

13. The system of claim 12, further comprising a gate at the base of the bulk storage container, the gate automatically moveable between an open position to a closed position upon command by the system controller.

14. The system of claim 13, further comprising a conveyor for automatically moving bulk animal feed from the gate to the dispensing station.

15. The system of claim 12 further comprising a scale disposed at the dispensing station, the scale configured to weigh the container when the container is in the dispensing station, the scale further configured to report a container weight to the system controller during dispensing of the bulk animal feed, the system controller configured to stop the dispensing of the bulk animal feed when a purchased weight has been dispensed.

16. The system of claim 12, wherein the dispensing station comprises a delivery sensor configured to sense the presence of an authorized container at the station and report the presence of the authorized container to the system controller, the system controller further configured to initiate dispensing of bulk animal feed only into the authorized container.

17. The system of claim 12 further comprising a dispensing station door and a door lock, the door lock automatically actuatable from a locked position to an unlocked position.

18. The system of claim 17, wherein the system controller is configured to unlock the door lock after a consumer purchases bulk animal feed using the point of sale terminal, and to re-lock the door lock before initiating dispensing of bulk animal feed.

19. The system of claim 12, further comprising displays associated with each dispensing station, the displays configured to display product information to the consumer.

20. The system of claim 12, further comprising a remote computer, the remote computer located remotely from the enclosure, the remote computer in communication with the system controller over a network, the remote computer configured to monitor the system.

21. The system of claim 20, the remote computer further configured to initiate sales of bulk animal feed remotely, the bulk animal feed to be dispensed at the dispensing station.
